(19) United States
(12) Patent Application Publication
(10) Pub. No.: US 2013/0111728 A1
(43) Pub. Date: May 9, 2013

(54) COMPONENT FASTENING LOCATION SYSTEM

(71) Applicants: Steve Frank, Dearborn, MI (US); Paul E. Turino, Allen Park, MI (US); Sinisa Samardzic, LaSalle (CA)

(72) Inventors: Steve Frank, Dearborn, MI (US); Paul E. Turino, Allen Park, MI (US); Sinisa Samardzic, LaSalle (CA)

(73) Assignee: FORD GLOBAL TECHNOLOGIES, LLC, DEARBORN, MI (US)

(21) Appl. No.: 13/292,109

(22) Filed: Nov. 9, 2011

(51) Int. Cl. B23P 11/00; B23P 19/00

(52) U.S. Cl. 29/428; 29/700

(57) ABSTRACT

A method of assembling a first component to a second component is described. The method includes placing the first component on a fixture having a locator pin, the pin being received in an opening in the first component. Sequentially, the second component is placed on the fixture with the pin being received in a slot in the second component. The slot may be configured to have one end wider than an opposite narrower end. A configuration such as this enables the pin to be received in the wider end of the slot. Consequently, sliding the second component all the way to the narrower end, clearing the pin, relative to the first component, reinforces the two components together.

### BACKGROUND

This application relates generally to fastening together components, and more particularly to the field of fastening together sheet metal components, especially vehicular sheet metal components.

In conventional assembly line practices on manufacturing shop floors, the assembling of sheet metal components is generally assisted by a guiding means, such as a locator pin. Locator pins function to guide and locate a first sheet metal component in relation to a second sheet metal component. The components, once positioned in relation to each other, are operated upon with assembly specific operations, for example, welding or fastening, before becoming a part of the final vehicle.

In current practice, certain reinforcements are employed during such assembly operations. A donut ring for example, can be placed around the locator pin, to reinforce a sheet metal component. The donut ring strengthens the hole it surrounds and prevents the sheet metal surface from rupturing or tearing. In mass production, however, the addition of reinforcements add time and expense to the assembly process, and as well as additional weight.

Accordingly, there exists room for improvements and alternatives to address such assembly operations, shortening the overall time, reducing the existing costs and weight involved. It would thus be highly desirable to have a system that efficiently reinforces sheet metal components, reducing the likelihood of sheet metal rupturing, and that functions in a simple fashion.

### SUMMARY

One embodiment of the present application describes a method of assembling a first component to a second component using a fixture having a pin. By placing the first component on the fixture, the pin is received in an opening in the first component. Consequently, the second component is placed on the fixture, the pin being received in a slot in the second component, the slot configured to have one end wider than an opposite narrower end. The wider end of the slot is adapted to receive the pin. Sliding the second component relative to the first component enables the pin reach the narrower end of the slot, assembling and reinforcing the components together.

Another embodiment of the present application discloses a system for assembling a first sheet metal component and a second sheet metal component to each other. A locator pin is positioned in an opening in the first sheet metal component, and is received in a slot configured in the second sheet metal component. The slot is structured to have a first end wider than an opposite narrower end, and is adapted to receive the locator pin in the wider end. The second sheet metal component reinforces the first sheet metal component as the second sheet metal component slides along the locator pin to the narrower end of the slot.

### BRIEF DESCRIPTION OF THE DRAWINGS

The figures described below set out and illustrate a number of exemplary embodiments of the disclosure. Throughout the drawings, like reference numerals refer to identical or functionally similar elements. The drawings are illustrative in nature and are not drawn to scale.

FIG. 1 is perspective view of an exemplary embodiment of vehicular sheet metal components assembled and reinforced according to the present disclosure.

FIG. 2 is an enlarged view of a portion of the components shown in FIG. 1.

FIG. 3 is a side view, partially broken away, of the sheet metal components engaging with each other according to the present disclosure.

FIG. 4A illustrates a slot in a tail lamp can and a locator pin in a body side outer panel, at the start of an assembly process according to the present disclosure.

FIG. 4B illustrates the position of the sheet metal components in relation to the locator pin, halfway through the assembly process.

FIG. 4C illustrates the position of the tail lamp can in a home position, completely assembled to the body side outer panel, at the end of the assembly process.

### DETAILED DESCRIPTION

The following detailed description is made with reference to the figures. Exemplary embodiments are described to illustrate the subject matter of the disclosure, not to limit its scope, which is defined by the appended claims.

### Overview

In general, the present disclosure describes methods and systems to assemble a first sheet metal component, namely a vehicular body side outer panel, and a second sheet metal component, namely a vehicular tail lamp can. An opening in the body side outer panel provides for a locator pin to be positioned through it, onto which the tail lamp can is placed and positioned for assemblage. A slot in a portion of the tail lamp can has a wider end and an opposite narrower end. The wider end of the slot conforms to a wall on the tail lamp can, enabling a mouth opening at the wider end, thus allowing the insertion of the locator pin into the slot. Positioning and sliding the slot all the way, clearing the locator pin to the opposite narrower end enables the tail lamp can to be reinforced onto the body side outer panel effectively. Welding or fastening operations can be performed on the assembly thereon.

### Exemplary Embodiments

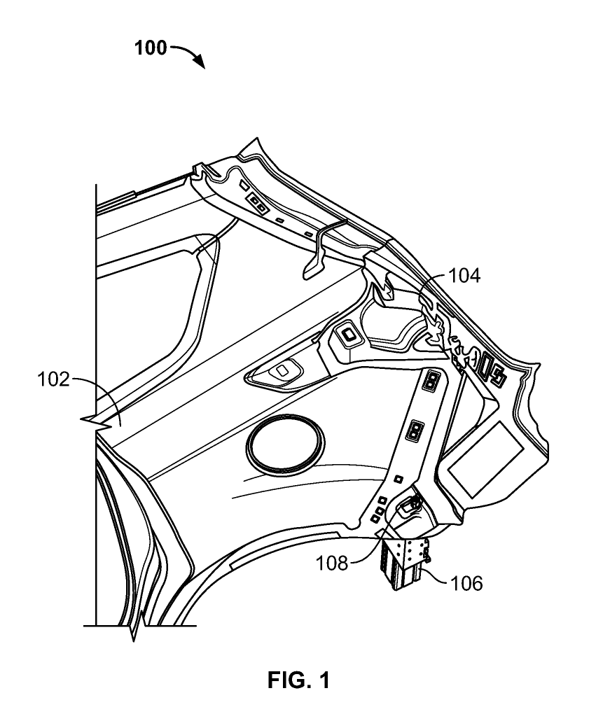

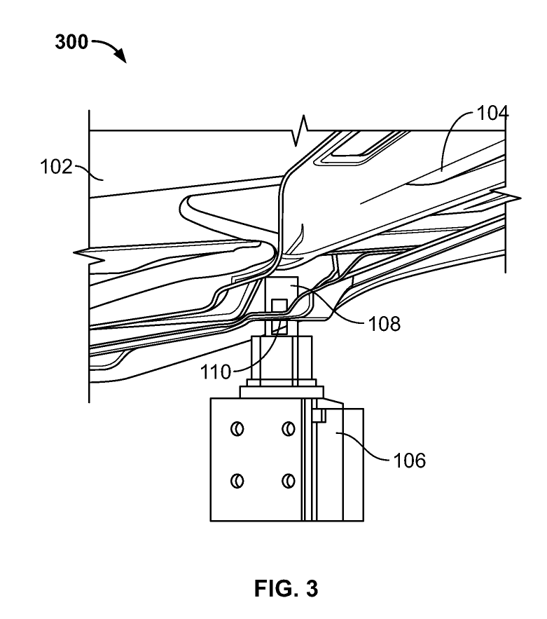

FIG. 1 illustrates an exemplary embodiment of an assembled sheet metal structure 100 of a vehicular rear panel. A first component, made of sheet metal, is stationed in the assembly line during an assembly process. A second component, also made of sheet metal, is positioned to be assembled over the first component. The first sheet metal component disclosed here is a vehicular body side outer panel 102, and the second sheet metal component is a vehicular tail lamp can 104. A pin such as a locator pin 108 is positioned through an opening 110 (Shown in FIG. 3) in the surface of the body side outer panel 102, by a fixture, such as a master locator tooling 106.

The body side outer panel 102 serves as the main vehicular structure, and other structural components are assembled onto this structure. The opening 110 is incorporated into the body side outer panel 102 to allow the locator pin 108 to be received and positioned through the body surface. An arrangement such as this allows other sheet metal components to be assembled to the body side outer panel 102 with a common point of reference and positioning. To ensure accurate positioning of the assembled components, the opening 110 is sized in accordance with the external conformations of the locator pin 108.

During assembly, the master locator tooling 106 is located to one side of the body side outer panel 102, opposite to the assembly operations, as shown, and may comprise mechanisms to “pull in” and “push out” the locator pin 108. Once the assembly operations are performed, the master locator tooling 106 enables the removal of the locator pin 108 from the assembled structure. The master locator tooling 106 may also include measures such as actuators (not shown) located within the locator pin 108 to aid reinforcement of the tail lamp can 104 to the body side outer panel 102.

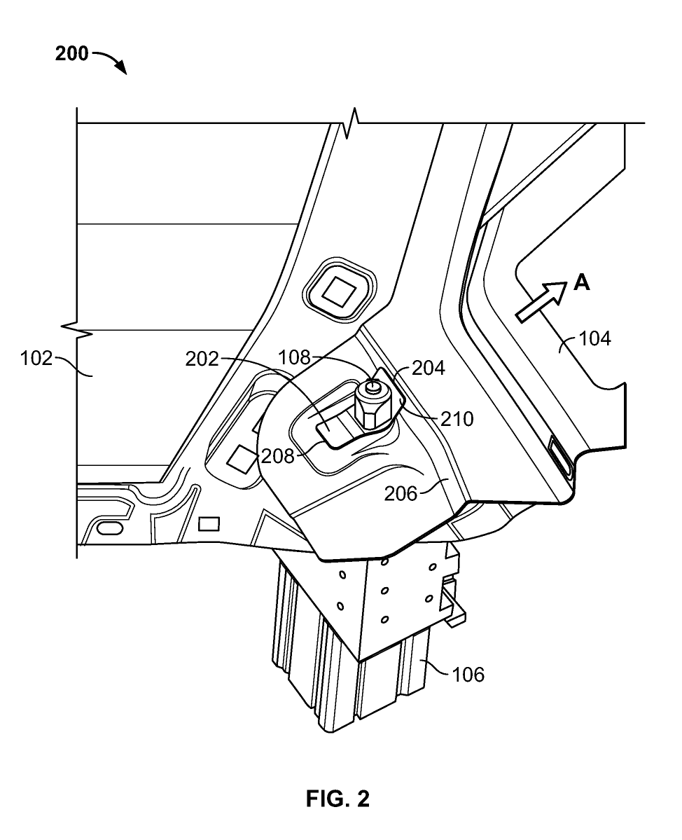

A slot 202 disposed in the tail lamp can 104, shown in an enlarged view 200 of the assembled sheet metal structure 100, in FIG. 2, enables the tail lamp can 104 to be assembled to the body side outer panel 102. The slot 202 has a first end, which is a wider end 204 on one side, and a second end, which is a narrower end 208 on the opposite side. More particularly, the wider end 204 is formed in a wall 206 of the tail lamp can 104, and defines a mouth opening 210 to the slot 202 at the wider end 204. The mouth opening 210, as described, is designed for providing a smooth entrance passage for the locator pin 108, or even other guide tools etc. (not shown), into the slot 202. The close juxtaposition between the body side outer panel 102 and the tail lamp can 104 reinforces the components and the component openings. More particularly, the tail lamp can 104 is assembled to the body side outer panel 102 in the direction of loading A, as depicted in FIG. 2.

In operation, the body side outer panel 102, once stationed in the assembly line, receives the master locator tooling 106 on a side, opposite to which assembly operations are carried out. Consequently, the master locator tooling 106 rigidly positions the locator pin 108 through the opening 110 (Shown in FIG. 3). The tail lamp can 104 is then brought over for assemblage to the body side outer panel 102 and is positioned in such a way that the slot 202 occupies a position adjacent to the locator pin 108. Under such a placement, the wider end 204 of the slot, conformed to the mouth opening 210, faces the locator pin 108. Starting at the mouth opening 210, the tail lamp can 104 is slid over the locator pin 108, according to the direction of loading A. The wider end 204 of the slot 202 receiving the locator pin 108 allows adequate tolerance for the locator pin 108 to slide past the mouth opening 210. As the sliding begins, the edge of the locator pin 108 acts as a lead into the locator trim edges of the slot 202. Sliding all the way to the narrower end 208 of the slot 202, the final position of the locator pin 108 enables the tail lamp can 104 to attain a reinforced position in relation to the body side outer panel 102. At this stage, the trim edges of the slot 202 engage the locator pin 108 to locate the tail lamp can 104. Welding and fastening operations are carried out on the assembly thus established.

FIG. 3 is a side view 300, partially broken away, of the sheet metal components engaging with each other. The figure illustrates the position of the tail lamp can 104 in relation to the body side outer panel 102 before the entry of the locator pin 108 into the slot 202 through the mouth opening 210. A clearance of a minimum of 6 mm is maintained between the locator pin 108 and the tail lamp can 104 at the mouth opening 210.

It will be understood that in place of the locator pin 108, as disclosed, any guiding tool positioned to slidably locate and reinforce a secondary component member on a primary body during an assembly process would be covered under the scope of the present disclosure.

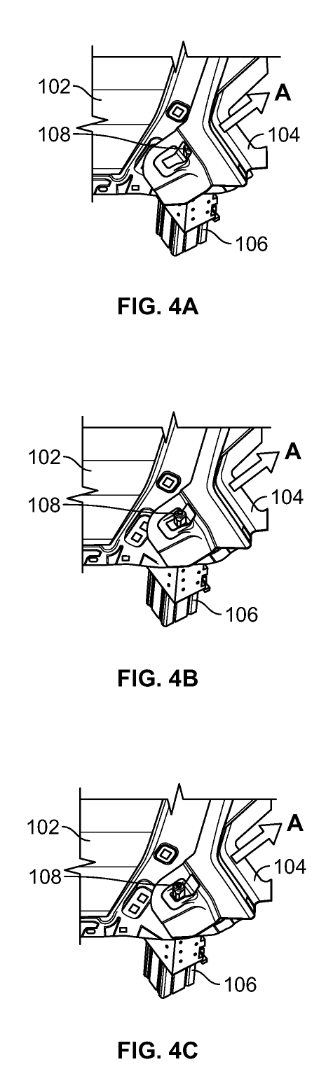

FIG. 4A, FIG. 4B, and FIG. 4C depict the method of assembling the two components namely, the tail lamp can 104 and the body side outer panel 102, to each other. The figures illustrate the positions of the two components in relation to each other during the assembly process.

FIG. 4A depicts the position of the body side outer panel 102 in relation to the tail lamp can 104, when the slot 202 of the tail lamp can 104 first receives the locator pin 108. At this position, the locator pin 108 first engages with the mouth opening 210 at the wider end 204 of the slot 202. More particularly, the tolerance maintained at the mouth opening 210 is sufficient for the locator pin 108 to slidably enter the slot 202. The locator pin 108 at this position is roughly at a distance of 100 mm from the desired assembled position.

FIG. 4B depicts the position of the body side outer panel 102 in relation to the tail lamp can 104, with the locator pin 108 positioned roughly midway in the slot 202. At this position, the locator pin 108 clears the wider end 204 and is about to engage with the narrower end 208 of the slot 202. The distance of the locator pin 108 from the desired final position is roughly 40 mm.

At the home position shown in the FIG. 4C, the locator pin 108 firmly establishes itself at the narrower end 208 of the slot 202, reinforcing the tail lamp can 104 to the body side outer panel 102. Having attained this desired assembled position; the structure thus obtained undergoes assembly related operations, like welding and fastening, and allows the locator pin 108 to be removed for the next assembly cycle.

The specification has set out a number of specific exemplary embodiments, but those skilled in the art will understand that variations in these embodiments will naturally occur in the course of embodying the subject matter of the disclosure in specific implementations and environments. It will further be understood that such variation and others as well, fall within the scope of the disclosure. Neither those possible variations nor the specific examples set above are set out to limit the scope of the disclosure. Rather, the scope of claimed invention is defined solely by the claims set out below.

We claim:

1. A method of assembling a first component and a second component using a fixture having a pin, the method comprising:
placing the first component on the fixture, the pin being received in an opening in the first component;
placing the second component on the fixture, the pin being received in a slot in the second component, the slot having a wider end and a narrower end, the pin being received in the wider end; and
sliding the second component relative to the first component, the pin being in the narrower end of the slot after the second component is slid relative to the first component.

2. The method of claim 1, wherein the second component reinforces the first component.

3. The method of claim 1, wherein the wider end of the slot, adapted to receive the pin, is formed on a wall in the second component, enabling a mouth opening at the wider end.

4. The method of claim 1, wherein the first component and the second component are made of sheet metal.

5. A system for assembling a first sheet metal component and a second sheet metal component to each other, the system comprising:
a locator pin positioned in an opening in the first sheet metal component;
a portion on the second sheet metal component structured to have a first end wider than an opposite narrower end;
a slot being configured to receive the locator pin at the first end, the second sheet metal component reinforcing the first sheet metal component as the second sheet metal component slides along the locator pin to the narrower end.

6. The system of claim 5, wherein the first end of the slot is formed on a wall in the second sheet metal component, enabling a mouth opening at the wider end.
